(19) United States
(12) Patent Application Publication
(10) Pub. No.: US 2015/0370816 A1
(43) Pub. Date: Dec. 24, 2015

(54) LOAD-BALANCING TECHNIQUES FOR AUDITING FILE ACCESSES IN A STORAGE SYSTEM

(71) Applicant: NETAPP, INC., Sunnyvale, CA (US)

(72) Inventors: Ved ANAND, Bangalore (IN); Vignesh NAYAK, Bangalore (IN); Devendra KUMAR, Bangalore (IN)

(73) Assignee: NETAPP, INC., Sunnyvale, CA (US)

(21) Appl. No.: 14/307,791

(22) Filed: Jun. 18, 2014

(51) Int. Cl. G06F 17/30; G06F 3/06

(52) U.S. Cl. CPC G06F 17/30091; G06F 17/30864; G06F 3/0608; G06F 3/0643; G06F 3/067

(57) ABSTRACT

Load-balancing techniques for auditing file accesses in a storage system are described. In one embodiment, for example, an apparatus may a processor circuit and a storage medium comprising instructions for execution by the processor circuit to receive a file access request notification identifying a stored file in a storage system, determine a destination volume for a file access record corresponding to an access of the stored file, the destination volume selected from among a plurality of candidate staging volumes of the storage system, and direct the file access record to the destination volume. Other embodiments are described and claimed.

### BACKGROUND

In a network storage cluster or other storage system, auditing may be implemented in order to maintain records of file accesses. Such records may be stored in specially designated staging volumes. In a storage system that comprises multiple aggregates, there may be a respective staging volume for each aggregate. Any particular aggregate may comprise multiple volumes, each of which may be tied to a respective virtual server (vserver). When a vserver accesses a file in a volume on a given aggregate, a record of that access may ordinarily be stored in the staging volume for that aggregate. A consolidation process operating on a management node may continually retrieve records from the staging volumes of the system, after which the retrieved records may be deleted at their respective staging volumes to make room for new records.

In some storage systems, guaranteed auditing techniques may be implemented, according to which the actual provision of file access is contingent upon successful storage of the associated record. If the rate of accesses to files at a given volume or aggregate is high, the rate at which records are added to corresponding staging volume may exceed the rate at which the consolidation process clears such records from the staging volume. If this condition persists, the staging volume may become full. In conventional systems, no alternative location is defined for storage of file access records in the event that a staging volume becomes full and cannot accept such records. Thus, when guaranteed auditing is implemented in conventional systems, requests to access files of a given volume may be denied when the corresponding staging volume is full.

### BRIEF DESCRIPTION OF THE DRAWINGS

FIG. 1 illustrates an embodiment of a first operating environment.

FIG. 2 illustrates an embodiment of a second operating environment.

FIG. 3 illustrates an embodiment of a third operating environment.

FIG. 4A illustrates a first embodiment of a status information entry.

FIG. 4B illustrates a second embodiment of the status information entry.

FIG. 4C illustrates a third embodiment of the status information entry.

FIG. 4D illustrates a fourth embodiment of the status information entry.

FIG. 5 illustrates an embodiment of a status information table.

FIG. 6 illustrates an embodiment of an apparatus and an embodiment of a system.

FIG. 7 illustrates an embodiment of a selection algorithm.

FIG. 8 illustrates an embodiment of a logic flow.

FIG. 9 illustrates an embodiment of a storage medium.

FIG. 10 illustrates an embodiment of a computing architecture.

FIG. 11 illustrates an embodiment of a communications architecture.

### DETAILED DESCRIPTION

Various embodiments may be generally directed to load-balancing techniques for auditing file accesses in a storage system. In one embodiment, for example, an apparatus may comprise a processor circuit and a storage medium comprising instructions for execution by the processor circuit to receive a file access request notification identifying a stored file in a storage system, determine a destination volume for a file access record corresponding to an access of the stored file, the destination volume selected from among a plurality of candidate staging volumes of the storage system, and direct the file access record to the destination volume. Other embodiments are described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

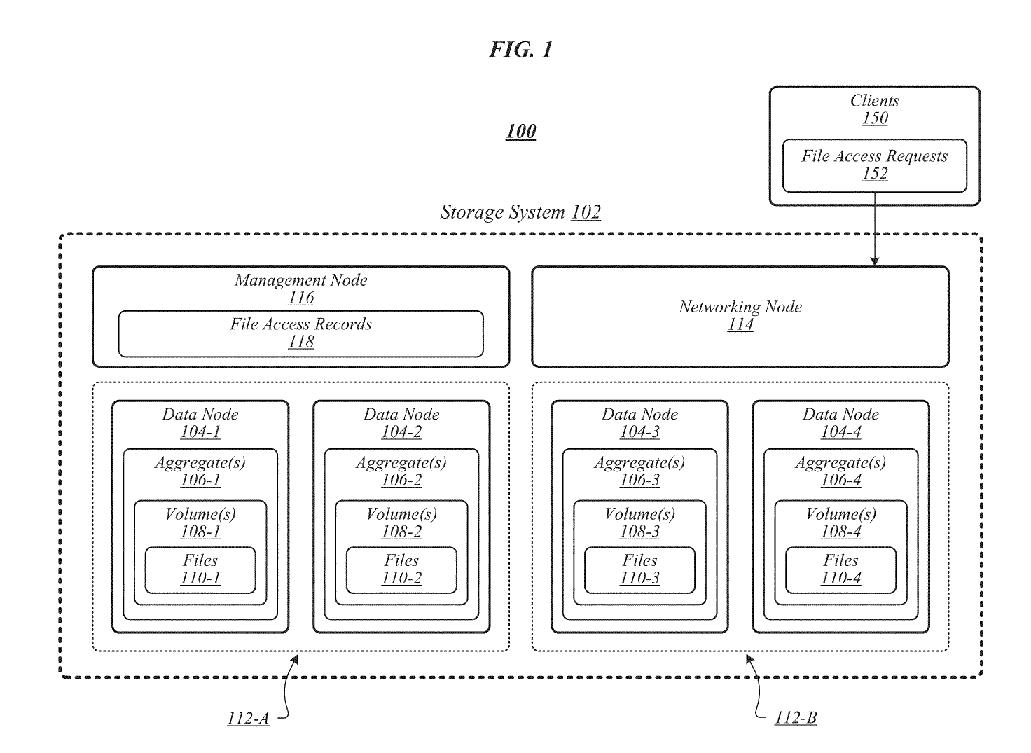

FIG. 1 illustrates an example of an operating environment 100 such as may be representative of various embodiments. More particularly, operating environment 100 may comprise an example of an operating environment in which load-balancing techniques may be implemented in some embodiments for auditing file accesses in a storage system 102. As shown in FIG. 1, in storage system 102, each of a plurality of data nodes 104 may store a set of respective files 110. The files 110 at each particular data node 104 may be comprised among one or more volumes 108. In turn, the one or more volumes 108 at each particular data node 104 may be comprised among one or more aggregates 106. In other words, each data node 104 may comprise one or more aggregates 106, which may each comprise one or more volumes 108, which may each in turn comprise one or more of the collective set of files 110 stored on that data node 104. In various embodiments, one or more high-availability (HA) pairs may be defined among the data nodes 104 in storage system 102. In the example of FIG. 1, data node 104-1 and data node 104-2 collectively comprise an HA-pair 112-A, and data node 104-3 and data node 104-4 collectively comprise an HA-pair 112-B. The embodiments are not limited to this example.

In some embodiments, the volumes 108 in storage system 102 may be associated with respective vservers, each of which may facilitate access by authorized clients 150 to the files 110 in its corresponding volume(s) 108. In order access to files 110 of their vservers, clients 150 may send file access requests 152 to a networking node 114, which may provide the clients 150 with file access in response to the file access requests 152. In conjunction with file access auditing for storage system 102, a management node 116 may maintain file access records 118 that comprise a log of those file accesses on the part of clients 150. In various embodiments, management node 116 may maintain file access records 118 by consolidating file access records that are generated and temporarily stored in staging volumes at the various data nodes 104 of storage system 102. The embodiments are not limited in this context.

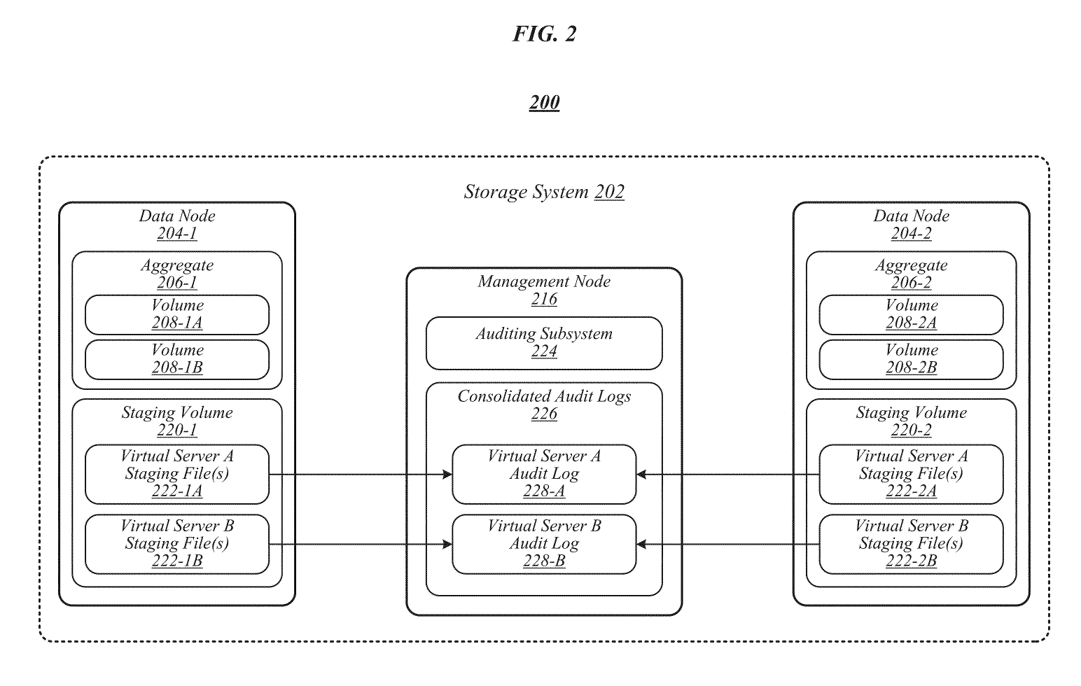

FIG. 2 illustrates an example of an operating environment 200, which may be representative of some embodiments in which a management node 216 consolidates file access records retrieved from data node staging volumes. As shown in FIG. 2, in example operating environment 200, a storage system 202 comprises the management node 216 and data nodes 204-1 and 204-2. Data node 204-1 comprises an aggregate 206-1, which in turn comprises a volume 208-1A that is accessible to a virtual server A, and a volume 208-1B that is accessible to a virtual server B. Similarly, data node 204-2 comprises an aggregate 206-2, which in turn comprises a volume 208-2A that is accessible to the virtual server A, and a volume 208-2B that is accessible to a virtual server B.

For purposes of file access auditing, each data node 204 may maintain a staging volume 220 for its aggregate 206. Each staging volume 220 may comprise a temporary storage location for access records associated with volumes of its corresponding aggregate. For example, staging volume 220-1 may comprise a temporary storage location for access records associated with volume 208-1A or 208-1B. Further, each staging volume 220 may contain a respective set of staging files 222 for each different virtual server to which any of the volumes on its aggregate correspond. For example, because volume 208-1A is accessible to virtual server A, staging volume 220-1 may contain a set of one or more virtual server A staging files 222-1A. Similarly, because volume 208-1B is accessible to virtual server B, staging volume 220-1 may contain a set of one or more virtual server B staging files 222-1B. It is worthy of note that although the example of FIG. 2 depicts only a single aggregate within each of data nodes 204-1 and 204-2, the embodiments are not so limited. In various embodiments, a single data node 204 may comprise multiple aggregates 206, and may comprise multiple corresponding staging volumes 220, each of which corresponds to a respective one of the multiple aggregates 206. The embodiments are not limited in this context.

In some embodiments, management node 216 may comprise an auditing subsystem 224. Auditing subsystem 224 may be operative to manage a consolidation process according to which the records in the staging files 222 in the respective staging volumes 220 of data nodes 204-1 and 204-2 are retrieved and combined in a set of consolidated audit logs 226. More particularly, according to the consolidation process, the file access records for each virtual server may be consolidated in a separate respective audit log. In the example of FIG. 2, the file access records that auditing subsystem 224 retrieves from virtual server A staging files 222-1A and virtual server A staging files 222-2A may be consolidated in a virtual server A audit log 228-A. Similarly, the file access records that auditing subsystem 224 retrieves from virtual server B staging files 222-1B and virtual server B staging files 222-2B may be consolidated in a virtual server B audit log 228-B. The embodiments are not limited in this context.

In various embodiments, during normal operation of storage system 202, records may continually be removed from the various staging volumes 220 as they are consolidated in the audit logs 228 by the consolidation process managed by auditing subsystem 224. Records also may continually be added to the various staging volumes 220 as file accesses are performed by clients of the virtual servers A and B. If a condition persists according to which records are added to a given staging volume 220 at a rate that exceeds the rate at which they are removed by the consolidation process, the staging volume 220 may eventually become full. If storage system 202 implements guaranteed auditing, then this may result in the rejection of all file access requests directed to volumes in the corresponding aggregate if the given staging volume 220 is the only location in which file access records for that aggregate may be stored. For example, if file access records for aggregate 206-1 may only be stored in staging volume 220-1 and staging volume 220-1 becomes full, then all requests to access files in volumes 208-1A and 208-1B of aggregate 206-1 may be denied until the consolidation process clears space within staging volume 220-1 for new records.

Disclosed herein are load-balancing techniques that may address this limitation of conventional systems. According to such load-balancing techniques, when a given staging volume approaches or reaches its capacity, an alternate staging volume may be selected to store file access records associated with the overburdened staging volume. For example, if staging volume 220-1 approaches or reaches its capacity, staging volume 220-2 may be selected to store file access records for volumes 208-1A and 208-1B of aggregate 206-1. In some embodiments, the selection of alternate staging volumes according to such load-balancing techniques may reduce the likelihood of access request rejections in guaranteed-audit storage systems. In various embodiments, the load-balancing techniques may include the establishment of an extra staging volume that may serve as an additional possible storage location for file access records. The embodiments are not limited in this context.

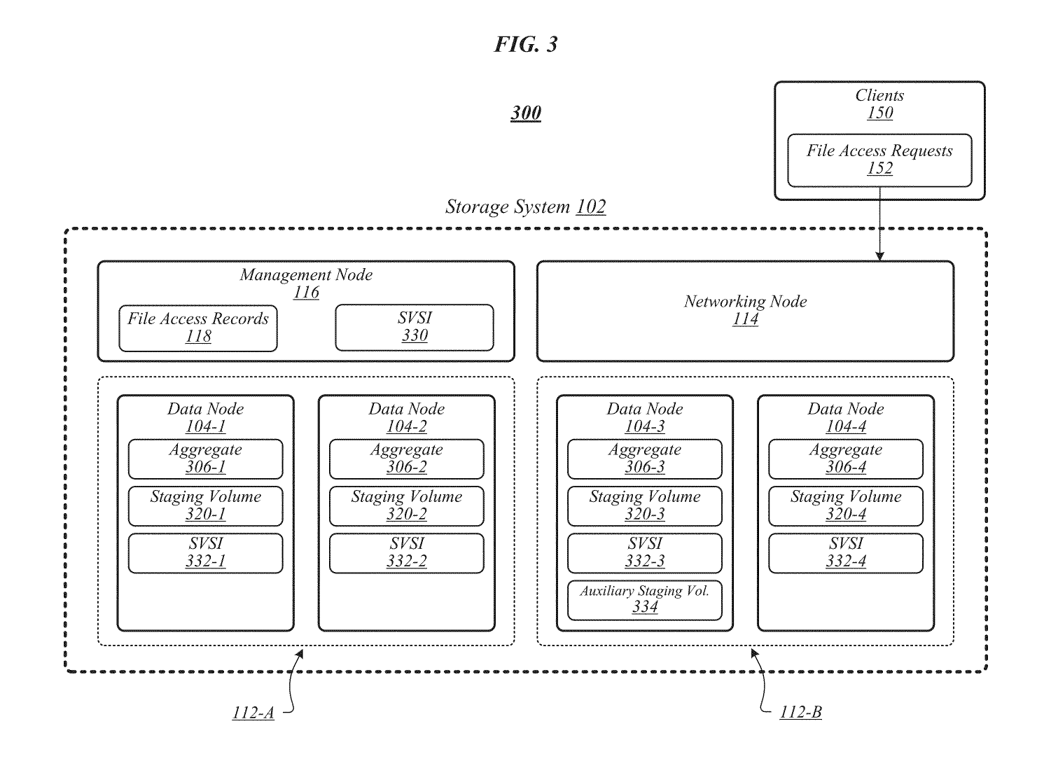

FIG. 3 illustrates an example of an operating environment 300 such as may be representative of some embodiments in which load-balancing techniques are implemented for auditing file accesses in storage system 102 of FIG. 1. As described with respect to FIG. 1, storage system 102 in FIG. 3 comprises networking node 114, management node 116, and data nodes 104-1, 104-2, 104-3, and 104-4, which may be arranged into HA-pairs 112-A and 112-B. In operating environment 300 of FIG. 3, each data node 104 comprises a single respective aggregate 306, as well as a staging volume 320 corresponding to that aggregate 306. As networking node 114 services file access requests 152 from clients 150, file access records 118 may be added to the various staging volumes 320. Concurrently, management node 116 may be operative to retrieve file access records 118 from the various staging volumes 320 for consolidation.

In operating environment 300, storage system 102 may implement guaranteed auditing. In order to reduce the likelihood of access request rejections, storage system 102 may use load-balancing techniques according to which any staging volume at any data node 104 within storage system 102 may be eligible for consideration as a candidate storage location for any particular file access record. For example, for an access record associated with a file in a volume within aggregate 306-1, not only staging volume 320-1 but also staging volumes 320-2, 320-3, and 320-4 may be eligible for consideration as candidate storage locations. In various embodiments, an auxiliary staging volume 334 may be created on one of the data nodes 104, and that auxiliary staging volume 334 may also be eligible for consideration as a candidate storage location for any particular file access record. In some embodiments, unlike the various staging volumes 320, the auxiliary staging volume 334 may not correspond to any particular aggregate, but rather may comprise an extra staging volume for use as a fallback storage location as any need may arise. The embodiments are not limited in this context.

In various embodiments, in order to assist the various data nodes 104 with the determination and/or consideration of the various candidate storage locations, management node 116 may be operative to generate, track, maintain, update, and/or distribute staging volume status information (SVSI) 330. SVSI 330 may comprise information describing various parameters, characteristics, and/or interrelationships of the various staging volumes 320 in storage system 102. In some embodiments, SVSI 330 may also include information describing parameters, characteristics, and/or interrelationships of auxiliary staging volume 334. In various embodiments, management node 116 may be operative to assemble and store SVSI 330 centrally, such that it is accessible to each data node 104 in storage system 102. In some embodiments, each data node 104 may be operative to access the centrally-stored SVSI 330 in order to obtain current information regarding the other data nodes 104 in storage system 102. In various embodiments, each data node 104 may maintain its own local SVSI 332, which it may continually update by accessing the centrally-stored SVSI 330.

In some embodiments, each time a given data node 104 needs to determine a storage location for an access record corresponding to a file in a volume that hosts, it may consult its local SVSI 332 in order to identify the appropriate storage location. In various embodiments, one or more parameters in the SVSI 332 may specify the storage location to be used for the access record. In some embodiments, following each occasion on which it causes an access record to be stored, a given data node 104 may be operative to update its SVSI 332 such that it identifies a storage location to be used for a next access record.

In various embodiments, the data node 104 may determine the storage location to be used for the next access record based on the statuses of the various staging volumes in the storage system 102. More particularly, in some embodiments, the data node 104 may use information in its SVSI 332 to apply a staging volume selection algorithm. In various embodiments, the staging volume selection algorithm may define an order in which various candidate storage locations are to be considered for selection. In some such embodiments, the staging volume selection algorithm may prioritize the various candidate storage locations based on their associated characteristics. For example, in various embodiments, the staging volume selection algorithm may prioritize the various candidate storage locations based on their proximity to the host data node 104, such that locations that reside on or near the host data node 104 are preferred. In some embodiments, the staging volume selection algorithm may prioritize the various candidate storage locations based on their available capacities. For example, in various embodiments, the staging volume selection algorithm may specify an exclusion threshold that defines a usage level that indicates, with respect to a staging volume 320 that exceeds that level, that the staging volume 320 will not be considered a candidate storage location for access records associated with files residing on other data nodes 104. The embodiments are not limited to these examples.

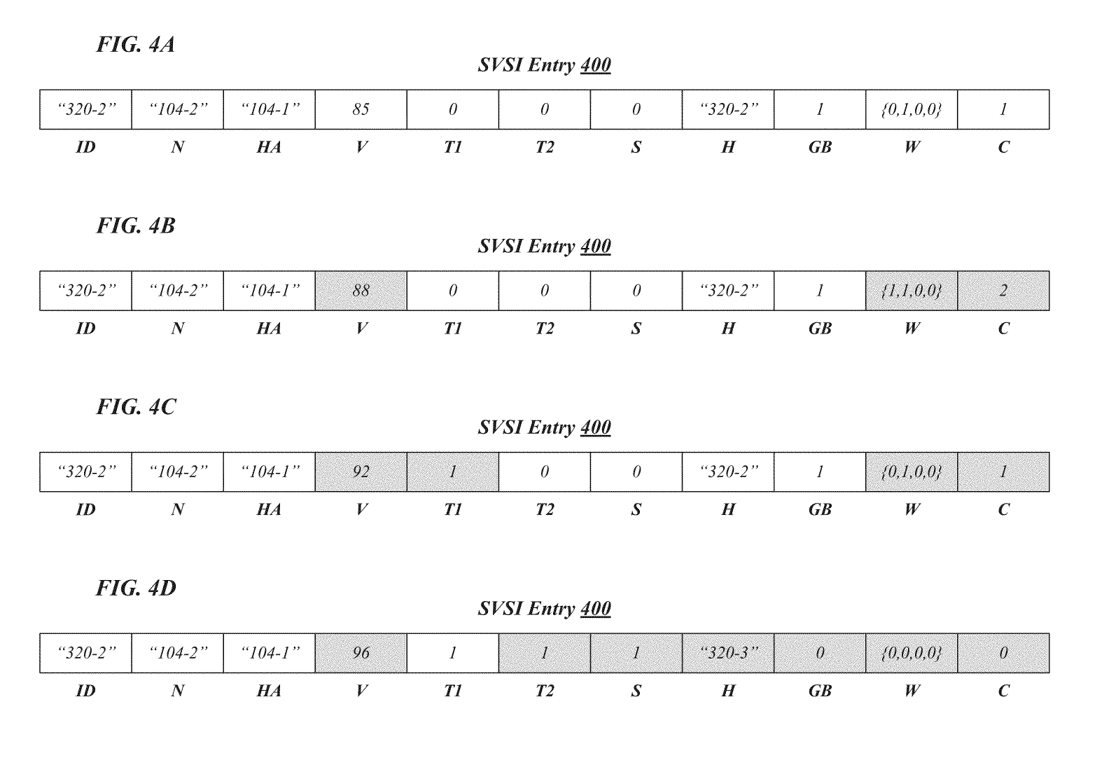

FIG. 4A illustrates an embodiment of an SVSI entry 400 such as may be representative of some embodiments. More particularly, SVSI entry 400 may comprise an example of an entry that may be contained in SVSI 330 and/or SVSI 332 of FIG. 3 in various embodiments. As shown in FIG. 4A, SVSI entry 400 comprises a plurality of data elements. In some embodiments, SVSI entry 400 may comprise an entry associated with a particular staging volume, and each of the plurality of data elements may describe a particular characteristic or set of characteristics of that staging volume. For purposes of explanation and not limitation, each such data element shall be discussed with reference to an example embodiment in which SVSI entry 400 is associated with staging volume 320-2 of FIG. 3.

In various embodiments, SVSI entry 400 may comprise a data element ID. In some embodiments, ID may comprise a value identifying the staging volume with which SVSI entry 400 is associated. In the example of FIG. 4A, since SVSI entry 400 is associated with staging volume 320-2 of FIG. 3, ID comprises the value “320-2.” In various embodiments, SVSI entry 400 may comprise a data element N. In some embodiments, N may comprise a value identifying the data node that contains the staging volume identified by ID. In the example of FIG. 4A, since staging volume 320-2 of FIG. 3 is contained in data node 104-2, N comprises the value “104-2.” In various embodiments, SVSI entry 400 may comprise a data element HA. In some embodiments, HA may comprise a value identifying an HA partner data node for the data node identified by N. In the example of FIG. 4A, since data node 104-1 of FIG. 3 is the HA partner for data node 104-2, HA comprises the value “104-1.”

In various embodiments, SVSI entry 400 may comprise a data element V. In some embodiments, V may comprise a value identifying a current usage level of the staging volume identified by ID. In various such embodiments, this value may be expressed as a percentage, from 0 to 100. In the example of FIG. 4A, V comprises a value of 85, indicating that staging volume 320-2 of FIG. 3 has been filled to 85 percent of its capacity.

In some embodiments, SVSI entry 400 may comprise a data element T1. In various embodiments, T1 may comprise a value indicating whether the usage level of the staging volume identified by ID has exceeded an exclusion threshold. In some embodiments, the exclusion threshold may comprise a usage level above which the staging volume identified by ID will not accept new access records associated with files residing on other data nodes. In various embodiments, T1 may comprise a value for a binary variable. In some embodiments, T1 may comprise a value of 0 if the relevant usage level has not exceeded the exclusion threshold, and may comprise a value of 1 if the relevant usage level has exceeded the exclusion threshold. In the example of FIG. 4A, the exclusion threshold may comprise a usage level of 90 percent. Since V indicates that the usage level of staging volume 320-2 of FIG. 3 is only 85 percent, T1 comprises a value of 0.

In various embodiments, SVSI entry 400 may comprise a data element T2. In some embodiments, T2 may comprise a value indicating whether the usage level of the staging volume identified by ID has exceeded a dependence threshold. In various embodiments, the dependence threshold may comprise a usage level above which the staging volume identified by ID will not accept any new access records, and thus above which a helper staging volume will need to be used to accommodate any new access records associated with files on the aggregate that corresponds to the staging volume identified by ID. In some embodiments, T2 may comprise a value for a binary variable. In various embodiments, T2 may comprise a value of 0 if the relevant usage level has not exceeded the dependence threshold, and may comprise a value of 1 if the relevant usage level has exceeded the dependence threshold. In the example of FIG. 4A, the dependence threshold may comprise a usage level of 95 percent. Since V indicates that the usage level of staging volume 320-2 of FIG. 3 is only 85 percent, T2 comprises a value of 0. This in turn indicates that staging volume 320-2 itself can be used to accommodate new access records associated with files on aggregate 306-2.

In some embodiments, SVSI entry 400 may comprise a data element S. In various embodiments, S may comprise a value indicating whether the staging volume identified by ID is currently being used to accommodate new access records associated with files on its corresponding aggregate. In some embodiments, S may comprise a value for a binary variable. In various embodiments, S may comprise a value of 0 if the staging volume identified by ID is currently being used to accommodate new access records associated with files on its corresponding aggregate, and may comprise a value of 1 is a different staging volume is currently being used to accommodate new access records associated with files on its corresponding aggregate. In the example of FIG. 4A, S comprises a value of 0, indicating that staging volume 320-2 of FIG. 3 is currently being used to accommodate new access records associated with files on aggregate 306-2.

In some embodiments, SVSI entry 400 may comprise a data element H. In various embodiments, H may comprise a value identifying the staging volume that is currently being used to accommodate new access records associated with files on the aggregate corresponding to the staging volume identified by ID. In the example of FIG. 4A, since S comprises a value of 0, H comprises the same value as ID.

In some embodiments, SVSI entry 400 may comprise a data element GB. In various embodiments, GB may comprise a value indicating whether a usage level of the staging volume identified by ID has fallen back below the exclusion threshold associated with T1 after having previously risen above the dependence threshold associated with T2. In some embodiments, GB may comprise a value for a binary variable. In various embodiments, GB may comprise a value of 1 if the usage level of the staging volume identified by ID has fallen back below the exclusion threshold associated with T1 after having previously risen above the dependence threshold associated with T2, and otherwise may comprise a value of 0. In the example of FIG. 4A, GB comprises a value of 1, which may be reflective of the usage level of staging volume 320-2 having previously risen above T2 and then having dropped below T1.

In some embodiments, SVSI entry 400 may comprise a data element W. In various embodiments, W may comprise a set of values indicating respective write-enable statuses for each of a plurality of staging volumes. In some embodiments, each write-enable status may define whether the staging volume identified by ID is to accept new access records associated with files residing on the respective aggregate that corresponds to a particular staging volume. In various embodiments, the set of values in W may include a respective value for each staging volume in a storage system that comprises the staging volume identified by ID. In some embodiments, W may comprise the form {E₁, E₂, . . . , E_{N}}, where E represents a value indicating a write-enable status for an i^{th} staging volume, and N represents the total number of staging volumes in the storage system. In various embodiments, each value E may comprise a value for a binary variable. In some embodiments, a value of 0 for E may indicate that the staging volume identified by ID is not to accept new access records that are associated with files residing on the aggregate that corresponds to the i^{th} staging volume, while a value of 1 may indicate that the staging volume identified by ID is to accept such access records. In the example of FIG. 4A, W comprises the set of values {0, 1, 0, 0}, indicating that staging volume 320-2 of FIG. 3 is currently only to accept new access records associated with files residing on its own corresponding aggregate 306-2.

In various embodiments, SVSI entry 400 may comprise a data element C. In some embodiments, C may comprise a value indicating a total number of aggregates for which the staging volume identified by ID is currently accepting new access records. In the example of FIG. 4A, since W indicates that staging volume 320-2 of FIG. 3 is currently only to accept new access records associated with files residing on its own corresponding aggregate 306-2, C comprises a value of 1.

FIG. 4B illustrates another embodiment of the SVSI entry 400 of FIG. 4A. More particularly, FIG. 4B illustrates changes that may occur with respect to various data elements in a scenario in which the described staging volume 320-2 of FIG. 3 has been selected to operate as a helper for staging volume 320-1. As shown in FIG. 4B, the W element indicates that staging volume 320-2 is configured to accept new access records associated with files residing on aggregate 306-1 as well as those associated with files residing on aggregate 306-2. Accordingly, the value of C has been incremented to 2. V indicates that staging volume 320-2 is now 88 percent full, but since this level is below the exclusion threshold of 90 percent associated with T1 and the dependence threshold of 95 percent associated with T2, the values for T1 and T2 remain at zero.

FIG. 4C illustrates another embodiment of the SVSI entry 400 of FIGS. 4A-4B. More particularly, FIG. 4C illustrates changes that may occur with respect to various data elements in a scenario in which the usage level of staging volume 320-2 of FIG. 3 rises from the 88 percent indicated by V in FIG. 4B to a level of 92 percent as indicated by V in FIG. 4C. Because this 92 percent usage level is greater than the exclusion threshold of 90 percent, the value of T1 has been changed to 1. This means that staging volume 320-2 is no longer to accept new access records associated with files residing on other data nodes. Since aggregate 306-1 resides on a different data node than aggregate 306-2, staging volume 320-2 is no longer to accept new access records associated with files in aggregate 306-1. As such, W has been updated to indicate that staging volume 320-2 is not to accept new access records associated with files residing on aggregate 306-1, and C has been updated accordingly.

FIG. 4D illustrates another embodiment of the SVSI entry 400 of FIGS. 4A-4C. More particularly, FIG. 4D illustrates changes that may occur with respect to various data elements in a scenario in which the usage level of staging volume 320-2 of FIG. 3 rises from the 92 percent indicated by V in FIG. 4C to a level of 96 percent as indicated by V in FIG. 4D. Because this 96 percent usage level is greater than the dependence threshold of 95 percent, the value of T2 has been changed to 1. This means that staging volume 320-2 is no longer to accept any new access records, and that a helper staging volume is to be used to accommodate any new access records associated with files on aggregate 306-2. In the example of FIG. 4D, staging volume 320-3 has been selected as helper, S has been updated to indicate that a helper staging volume is being used, and H has been updated to identify the helper staging volume as staging volume 320-3. Furthermore, GB, W, and C have been updated to appropriately reflect that staging volume 320-2 is not to accept any new access records, even those associated with its own aggregate. It is to be understood that the example scenarios of FIGS. 4A-4B are presented merely for purposes of explanation, and that the embodiments are not limited to these examples.

Returning to FIG. 3, in various embodiments, management node 116 may be operative to generate, track, maintain, update, and/or distribute SVSI 330 that comprises SVSI entries such as those illustrated in FIGS. 4A-4D. In some such embodiments, the SVSI 330 may include a respective SVSI entry for each staging volume 320 in storage system 102. Similarly, in various embodiments, local SVSI 332 maintained by data nodes 104 may include respective entries for each staging volume 320. In some embodiments, the SVSI 330 and/or any of the various sets of SVSI 332 may include an entry corresponding to auxiliary staging volume 334. In various embodiments, one or more data elements may be omitted from SVSI entries corresponding to auxiliary staging volume 334. For example, with respect to example SVSI entry 400 of FIGS. 4A-4D, in some embodiments, the T1, T2, and C parameters may be omitted from SVSI entries corresponding to auxiliary staging volume 334. In various embodiments, SVSI 330 and/or each set of SVSI 332 may comprise the form of an SVSI table, in which each row comprises an SVSI entry for a respective staging volume. The embodiments are not limited in this context.

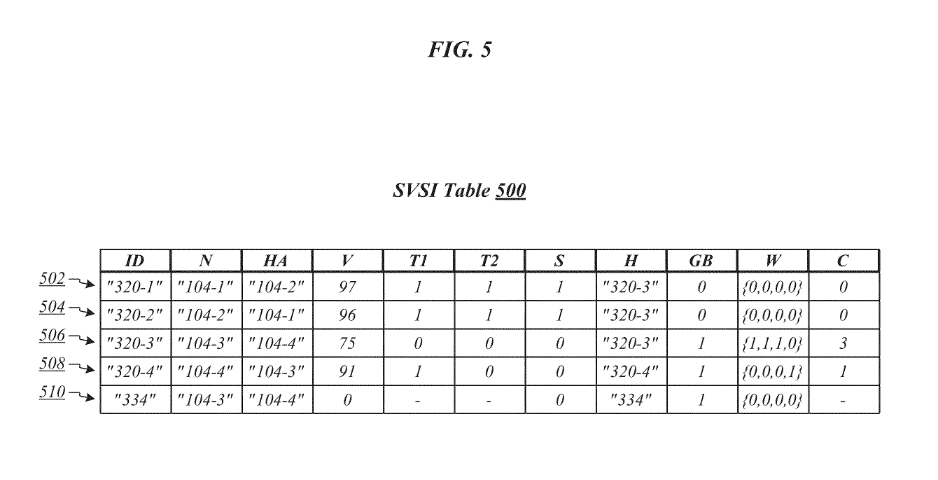

FIG. 5 illustrates an example of an SVSI table 500 such as may be representative of various embodiments. More particularly, with reference to FIG. 3, SVSI table 500 may comprise an example of a possible form of SVSI 330 and/or any particular set of SVSI 332 in some embodiments. As shown in FIG. 5, SVSI table 500 contains rows 502, 504, 506, 508, and 510, each of which comprises a respective SVSI entry of the form of SVSI entry 400 of FIGS. 4A-4D. As indicated by the values in the ID column, row 502 comprises an SVSI entry for staging volume 320-1, row 504 comprises an SVSI entry for staging volume 320-2, row 506 comprises an SVSI entry for staging volume 320-3, row 508 comprises an SVSI entry for staging volume 320-4, and row 510 comprises an SVSI entry for auxiliary staging volume 334. In the scenario depicted in SVSI table 500, as indicated by their T1 and T2 column values, the usage levels for both staging volume 320-1 and staging volume 320-2 have exceeded the exclusion and dependence thresholds. As indicated by their S and H column values, both staging volume 320-1 and staging volume 320-2 are being helped by staging volume 320-3. As indicated by their W and C column values, neither staging volume 320-1 nor staging volume 320-2 is configured to accept any new file access records.

Meanwhile, as indicated by the V, T1, and T2 column values in row 506, the usage level for staging volume 320-3 is only 75 percent, and has not exceeded either the exclusion threshold or the dependence threshold. As indicated by its S, H, W, and C column values, staging volume 320-3 is configured not only to accept access records associated with files on its own corresponding aggregate, but also to accept access records associated with files on the aggregates corresponding to staging volumes 320-1 and 320-2. With respect to staging volume 320-4, as indicated by its V, T1, and T2 column values in row 508, the usage level for staging volume 320-4 is 91 percent, and thus has exceeded the exclusion threshold, but not the dependence threshold. As such, staging volume 320-4 is configured to accept access records associated with files on its own corresponding aggregate, but not to accept access records associated with files on any of the aggregates residing on other data nodes. As indicated by the V and W column values in row 510, none of the capacity of auxiliary staging volume 334 is currently being used, and auxiliary staging volume 334 is not currently configured to accept access records associated with files on any of the various aggregates to which staging volumes 320-1, 320-2, 320-3, and 320-4 correspond. The embodiments are not limited to this example.

It is to be appreciated that although the exclusion and dependence thresholds have been depicted up to this point as being universal parameters that are the same for each staging volume, the embodiments are not so limited. In various embodiments, different exclusion thresholds and/or dependence thresholds may be defined for different staging volumes of a given storage system. For example, in some embodiments, the respective exclusion thresholds and/or dependence thresholds for the staging volumes in a given storage system may be selected based on observed access patterns for the various aggregates associated with those staging volumes. In another example, in various embodiments, the respective exclusion thresholds and/or dependence thresholds for the staging volumes in a given storage system may be selected in view of input/output (I/O) capabilities of the various data nodes on which the staging volumes reside. The embodiments are not limited to these examples.

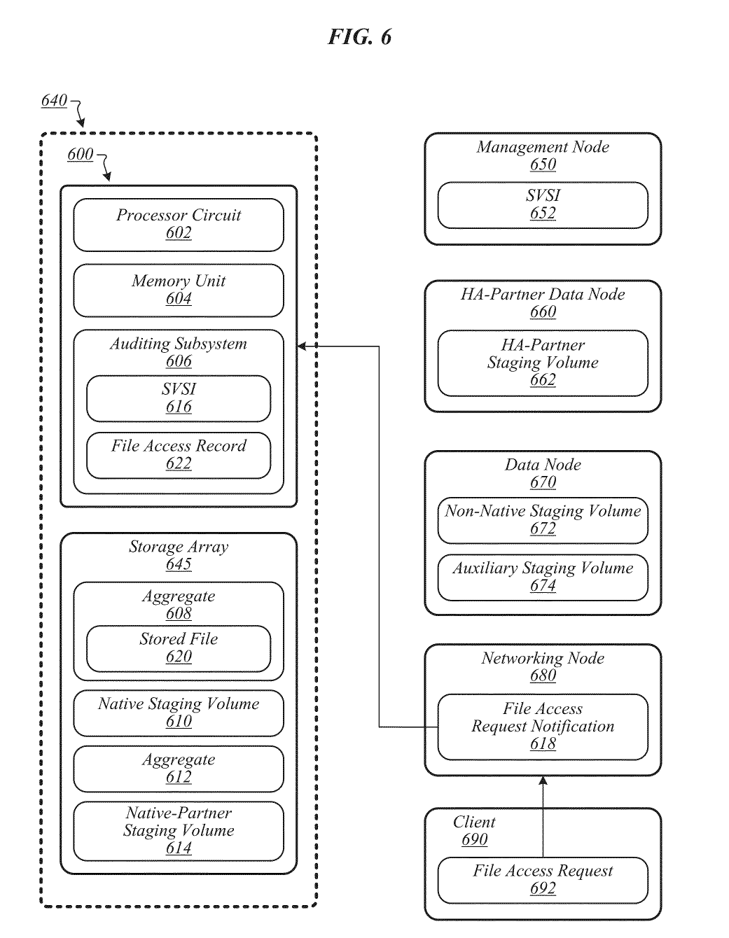

FIG. 6 illustrates a block diagram of an apparatus 600 such as may implement improved access management techniques. Apparatus 600 may comprise an example of a data node 104 of FIG. 3 according to some embodiments. As shown in FIG. 6, apparatus 600 comprises multiple elements including a processor circuit 602, a memory unit 604, and an auditing subsystem 606. The embodiments, however, are not limited to the type, number, or arrangement of elements shown in this figure.

In various embodiments, apparatus 600 may comprise processor circuit 602. Processor circuit 602 may be implemented using any processor or logic device, such as a complex instruction set computer (CISC) microprocessor, a reduced instruction set computing (RISC) microprocessor, a very long instruction word (VLIW) microprocessor, an x86 instruction set compatible processor, a processor implementing a combination of instruction sets, a multi-core processor such as a dual-core processor or dual-core mobile processor, or any other microprocessor or central processing unit (CPU). Processor circuit 602 may also be implemented as a dedicated processor, such as a controller, a microcontroller, an embedded processor, a chip multiprocessor (CMP), a co-processor, a digital signal processor (DSP), a network processor, a media processor, an input/output (UO) processor, a media access control (MAC) processor, a radio baseband processor, an application specific integrated circuit (ASIC), a field programmable gate array (FPGA), a programmable logic device (PLD), and so forth. The embodiments are not limited in this context.

In some embodiments, apparatus 600 may comprise or be arranged to communicatively couple with a memory unit 604. Memory unit 604 may be implemented using any machine-readable or computer-readable media capable of storing data, including both volatile and non-volatile memory. For example, memory unit 604 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy of note that some portion or all of memory unit 604 may be included on the same integrated circuit as processor circuit 602, or alternatively some portion or all of memory unit 604 may be disposed on an integrated circuit or other medium, for example a hard disk drive, that is external to the integrated circuit of processor circuit 602. Although memory unit 604 is comprised within apparatus 600 in FIG. 6, memory unit 604 may be external to apparatus 600 in some embodiments. The embodiments are not limited in this context.

In various embodiments, apparatus 600 may comprise an auditing subsystem 606. Auditing subsystem 606 may comprise logic, circuitry, and/or instructions operative to manage the creation and/or storage of file access records associated with files on one or more aggregates. In various embodiments, auditing subsystem 606 may be operative to manage one or more staging volumes corresponding to the one or more aggregates, and may be operative to store file access records in the one or more staging volumes. In some embodiments, the stored file access records may include file access records associated with files on aggregates other than those corresponding to the one or more staging volumes that auditing subsystem 606 manages. The embodiments are not limited in this context.

FIG. 6 also illustrates a block diagram of a system 640. System 640 may comprise any of the aforementioned elements of apparatus 600. System 640 may further comprise a storage array 645. Storage array 645 may comprise a set of physical storage devices, such as a set of hard disks and/or tape devices, and some or all of the storage resources of those physical storage devices may be allocated among one or more aggregates. The embodiments are not limited in this context.

During general operation, auditing subsystem 606 may be operative to manage auditing for an aggregate 608. In various embodiments, the aggregate 610 may be comprised in storage array 645. In some embodiments, auditing subsystem 606 may be operative to manage a native staging volume 610 that corresponds to the aggregate 608 and that resides on a same data node as the aggregate 608. In various embodiments, the native staging volume 610 may be comprised in the same storage array 645 as the aggregate 608. In some other embodiments, the native staging volume 610 may be comprised in a different storage array that resides on a same data node as the aggregate 608. The embodiments are not limited in this context.

In various embodiments, auditing subsystem 606 may be operative to manage auditing for multiple aggregates. For example, in some embodiments, a data node that comprises aggregate 608 may also comprise an aggregate 612, and auditing subsystem 606 may be operative to manage auditing for both the aggregate 608 and the aggregate 612. In various embodiments, the aggregate 608 and the aggregate 612 may both be comprised in storage array 645. In some embodiments, auditing subsystem 606 may be operative to manage a staging volume that corresponds to the aggregate 612. In various embodiments, this staging volume may comprise a native-partner staging volume with respect to aggregate 608. Herein, the term “native-partner staging volume” is employed to denote, with respect to a given staging volume, another staging volume residing on a same data node as the given staging volume. FIG. 6 depicts an example in which aggregates 608 and 612 reside on a same storage array 645 at a same data node, and thus the staging volume corresponding to aggregate 612 is labeled as a native-partner staging volume 614. It is to be understood that while native-partner staging volume 614 may comprise a native-partner staging volume with respect to aggregate 608, it may also comprise a native staging volume with respect to aggregate 612. The embodiments are not limited in this context.

In some embodiments, auditing subsystem 606 may be operative to generate, track, maintain, update, and/or distribute staging volume status information (SVSI) 616. SVSI 616 may comprise information describing various parameters, characteristics, and/or interrelationships of the various staging volumes in a storage system in which apparatus 600 and/or system 640 is comprised. In various embodiments, SVSI 616 may comprise a plurality of SVSI entries, each of which corresponds to a particular staging volume. In some embodiments, such entries may be the same as or similar to SVSI entry 400 of FIGS. 4A-4D. In various embodiments, SVSI 616 may comprise an SVSI table made up of such SVSI entries, such as SVSI table 500 of FIG. 5. In some embodiments, in conjunction with maintenance of SVSI 616, auditing subsystem 606 may be operative to communicate with a management node 650, which may be the same as or similar to management node 116 of FIGS. 1 and 3. More particularly, in various embodiments, the management node 650 may maintain and centrally store SVSI 652, and auditing subsystem 606 may be operative to update SVSI 616 based on information it obtains from SVSI 652. In some embodiments, auditing subsystem 606 may additionally or alternatively be operative to provide management node 650 with updated status information regarding native staging volume 610 and/or native-partner staging volume 614, for inclusion into SVSI 652. The embodiments are not limited in this context.

In various embodiments, SVSI 616 may include status information for native staging volume 610 and native-partner staging volume 614. In some embodiments, SVSI 616 may additionally include status information for one or more staging volumes that reside on different data nodes than a data node on which native staging volume 610 and native-partner staging volume 614 reside. For example, in various embodiments, SVSI 616 may include status information for an HA-partner staging volume 662 residing on an HA-partner data node 660 that comprises an HA partner for apparatus 600 and/or system 640. In another example, in some embodiments, SVSI 616 may include status information for a non-native staging volume 672 residing on a data node 670 that comprises a different data node within a same storage system as apparatus 600 and/or system 640. In yet another example, in various embodiments, SVSI 616 may include status information for an auxiliary staging volume 674. Auxiliary staging volume 674 may comprise an extra staging volume for use as a fallback storage location for file access records in a storage system in which apparatus 600 and/or system 640 is comprised, and may be the same as or similar to auxiliary staging volume 334 of FIG. 3. The embodiments are not limited in this context.

It is to be appreciated that although auxiliary staging volume 674 is depicted in FIG. 6 as being external to apparatus 600 and/or system 640 and as being comprised within a same data node as non-native staging volume 672, the embodiments are not so limited. In some other embodiments, auxiliary staging volume 674 may be comprised within HA-partner data node 660, or within another data node of a storage system that comprises apparatus 600 and/or system 640. In yet other embodiments, auxiliary staging volume 674 may be comprised within storage array 645 and/or within a same data node as native staging volume 610 and native-partner staging volume 614. The embodiments are not limited in this context.

In various embodiments, apparatus 600 and/or system 640 may be operative to receive a file access request notification 618 that identifies a stored file 620 on aggregate 608 and indicates that a client has requested access to that stored file 620. In some embodiments, apparatus 600 and/or system 640 may be operative to receive the file access request notification 618 from an external device to which the client has sent its request. For example, in various embodiments, apparatus 600 and/or system 640 may be operative to receive the file access request notification 618 from a networking node 680, which may be the same as or similar to networking node 114 of FIGS. 1 and 3. In some embodiments, a client 690 may send a file access request 692 to networking node 680 to request access to stored file 620, and networking node 680 may send the file access request notification 618 to apparatus 600 and/or system 640 in response to the file access request 692. In various embodiments, auditing subsystem 606 may be operative to determine the respective staging volumes that constitute native staging volume 610 and native-partner staging volume 614 based on the stored file 620 being located within aggregate 608. More particularly, auditing subsystem 606 may be operative to identify a staging volume that corresponds to aggregate 608 as the native staging volume 610, and may be operative to identify a staging volume that corresponds to aggregate 612 as a native-partner staging volume 614. The embodiments are not limited in this context.

In some embodiments, auditing subsystem 606 may be operative to determine a destination volume for a file access record 622 corresponding to an access of the stored file 620. For example, in various embodiments, auditing subsystem 606 may be operative to determine a destination volume for a file access record 622 that describes access to stored file 620 that is granted to client 690 based on file access request 692. In some embodiments, the destination volume may comprise a staging volume selected from among a plurality of candidate staging volumes comprised in a storage system in which apparatus 600 and/or system 640 is comprised. In various embodiments, auditing subsystem 606 may be operative to determine the destination volume based on SVSI 616. In some embodiments, auditing subsystem 606 may be operative to determine the destination volume by using SVSI 616 to apply a staging volume selection algorithm. In various embodiments, the staging volume selection algorithm may define an order in which various candidate staging volumes are to be considered for selection as the destination volume. In some embodiments, according to the staging volume selection algorithm, the consideration of any particular candidate staging volume may be performed based on information comprised in SVSI 616.

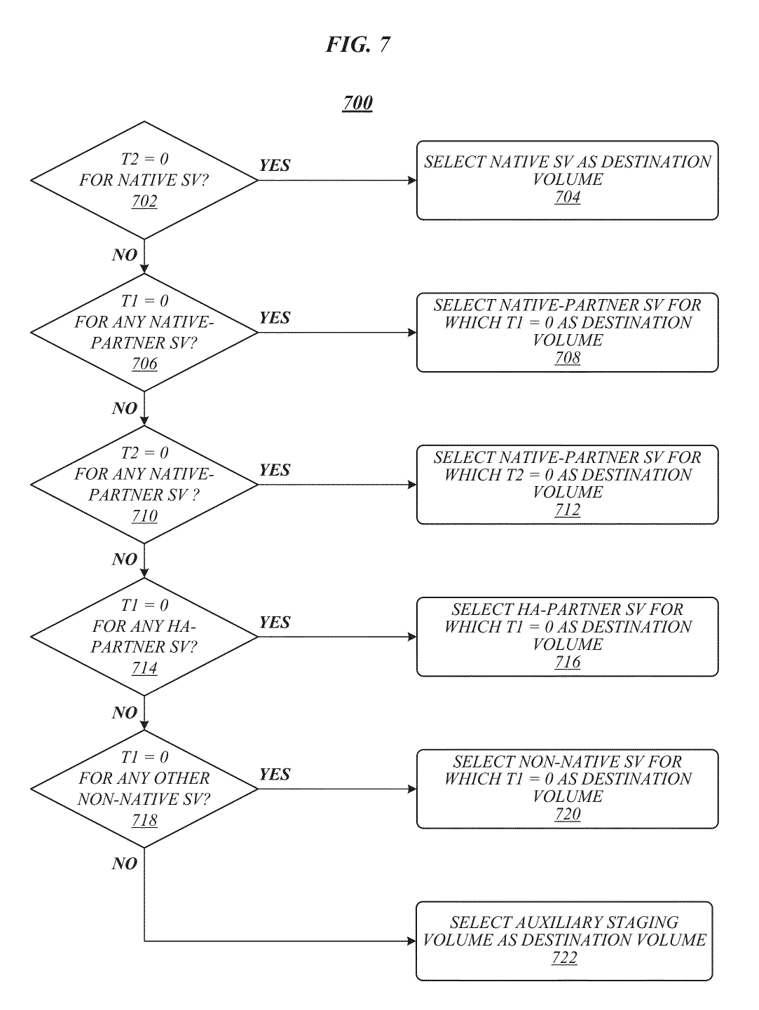

FIG. 7 illustrates an example of a staging volume selection algorithm 700 such as may be representative of various embodiments. More particularly, staging volume selection algorithm 700 may comprise an example of a staging volume selection algorithm that may be employed in some embodiments by auditing subsystem 606 of FIG. 6 in order to determine a destination volume for file access record 622. As shown in FIG. 7, at 702, it may be determined whether T2 is equal to 0 for the native staging volume of the file to be accessed, and thus whether the usage level for the native staging volume is less than the dependence threshold. For example, auditing subsystem 606 of FIG. 6 may be operative to determine whether the usage level for native staging volume 610 is less than the dependence threshold. If it is determined at 702 that the usage level for the native staging volume is less than the dependence threshold, flow may pass to 704, where the native staging volume may be selected as the destination volume for the file access record. For example, auditing subsystem 606 may be operative to select native staging volume 610 as the destination volume for file access record 622 if the usage level for the native staging volume 610 is less than the dependence threshold. If it is determined at 702 that the usage level for the native staging volume is greater than the dependence threshold, flow may pass to 706.

At 706, it may be determined whether T1 is equal to 0 for any native-partner staging volume, and thus whether the respective usage level for any native-partner staging volume is less than the exclusion threshold. For example, auditing subsystem 606 of FIG. 6 may be operative to determine whether the usage level for native-partner staging volume 614 is less than the exclusion threshold. If it is determined at 706 that the usage level for any native-partner staging volume is less than the exclusion threshold, flow may pass to 708, where one such native-partner staging volume may be selected as the destination volume for the file access record. For example, auditing subsystem 606 may be operative to select native-partner staging volume 614 as the destination volume for file access record 622 if the usage level for native-partner staging volume 614 is less than the exclusion threshold. If it is determined at 706 that there is no native-partner staging volume for which the usage level is less than the exclusion threshold, flow may pass to 710.

At 710, it may be determined whether T2 is equal to 0 for any native-partner staging volume, and thus whether the respective usage level for any native-partner staging volume is less than the dependence threshold. For example, auditing subsystem 606 of FIG. 6 may be operative to determine whether the usage level for native-partner staging volume 614 is less than the dependence threshold. If it is determined at 710 that the usage level for any native-partner staging volume is less than the dependence threshold, flow may pass to 712, where one such native-partner staging volume may be selected as the destination volume for the file access record. For example, auditing subsystem 606 may be operative to select native-partner staging volume 614 as the destination volume for file access record 622 if the usage level for native-partner staging volume 614 is less than the dependence threshold. If it is determined at 710 that there is no native-partner staging volume for which the usage level is less than the dependence threshold, flow may pass to 714.

At 714, it may be determined whether T1 is equal to 0 for any HA-partner staging volume, and thus whether the respective usage level for any HA-partner staging volume is less than the exclusion threshold. For example, auditing subsystem 606 of FIG. 6 may be operative to determine whether the usage level for HA-partner staging volume 662 is less than the exclusion threshold. If it is determined at 714 that the usage level for any HA-partner staging volume is less than the exclusion threshold, flow may pass to 716, where one such HA-partner staging volume may be selected as the destination volume for the file access record. For example, auditing subsystem 606 may be operative to select HA-partner staging volume 662 as the destination volume for file access record 622 if the usage level for HA-partner staging volume 662 is less than the exclusion threshold. If it is determined at 714 that there is no HA-partner staging volume for which the usage level is less than the exclusion threshold, flow may pass to 718.

At 718, it may be determined whether T1 is equal to 0 for any non-native staging volume not considered at 714, and thus whether the respective usage level for any such non-native staging volume is less than the exclusion threshold. For example, auditing subsystem 606 of FIG. 6 may be operative to determine whether the usage level for non-native staging volume 672 is less than the exclusion threshold. If it is determined at 718 that the usage level for any such non-native staging volume is less than the exclusion threshold, flow may pass to 720, where one such non-native staging volume may be selected as the destination volume for the file access record. For example, auditing subsystem 606 may be operative to select non-native staging volume 672 as the destination volume for file access record 622 if the usage level for non-native staging volume 672 is less than the exclusion threshold. In some embodiments, in the event that there are multiple non-native staging volumes for which the respective usage levels are less than the exclusion threshold, the non-native staging volume among them that is currently serving the lowest number of staging volumes may be selected as the destination volume. If it is determined at 718 that there is no non-native staging volume for which the usage level is less than the exclusion threshold, flow may pass to 722, where an auxiliary staging volume may be selected as the destination volume for the file access record. For example, auditing subsystem 606 of FIG. 6 may be operative to select auxiliary staging volume 674 as the destination volume for file access record 622 if there is no non-native staging volume for which the usage level is less than the exclusion threshold. The embodiments are not limited to these examples.

Returning to FIG. 6, it is worthy of note that auditing subsystem 606 may not necessarily apply the staging volume selection algorithm subsequent to receipt of file access request notification 618. For example, in various embodiments, auditing subsystem 606 may be operative to periodically update SVSI 616, and may be operative during each update to determine the destination volume that will be used to store file access records associated with subsequently received file access request notifications. As such, in some embodiments, following receipt of file access request notification 618, auditing subsystem 606 may be operative to determine the destination volume for file access record 622 simply by consulting SVSI 616 to identify the staging volume that it indicates should be used. For example, in various embodiments, with reference to SVSI table 500 of FIG. 5, auditing subsystem 606 may be operative to determine the destination volume for file access record 622 as the staging volume identified by the H column value in a row corresponding to native staging volume 610. In some such embodiments, this value may have been determined by application of the staging volume selection algorithm during a most recent update of SVSI 616. The embodiments are not limited in this context.

In various embodiments, following determination of the destination volume, auditing subsystem 606 may be operative to direct file access record 622 to the destination volume. In some embodiments, auditing subsystem 606 may itself be operative to generate the file access record 622. In various such embodiments, the destination volume may comprise native staging volume 610 or native-partner staging volume 614, and auditing subsystem 606 may be operative to store file access record 622 in one of these staging volumes. In some other embodiments, the destination volume may comprise a staging volume residing on an external data node, and auditing subsystem 606 may be operative to send the file access record 622 to the destination volume over a communication connection between the external data node and apparatus 600 and/or system 640. In yet other embodiments, file access record 622 may be generated by a node that is external to apparatus 600 and/or system 640, and auditing subsystem 606 may be operative to direct file access record 622 to the destination volume by sending an instruction to that external node. The embodiments are not limited in this context.

In various embodiments, auditing subsystem 606 may be operative to update SVSI 616 following direction of file access record 622 to the destination volume. For example, in some embodiments in which native staging volume 610 comprises the destination volume, auditing subsystem 606 may be operative to update SVSI 616 to reflect the increased usage level associated with storage of file access record 622 in native staging volume 610. In various embodiments, in conjunction with updating SVSI 616, auditing subsystem 606 may be operative to employ a staging volume selection algorithm such as staging volume selection algorithm 700 of FIG. 7 to update parameters in SVSI 616 that indicate the destination volume to be used for a next prospective file access record. For example, in some embodiments, with reference to SVSI table 500 of FIG. 5, auditing subsystem 606 may be operative to update the H column value in a row corresponding to native staging volume 610. In various embodiments, auditing subsystem 606 may be operative to communicate with management node 650 to provide updated status information regarding native staging volume 610 and/or native-partner staging volume 614, for inclusion into SVSI 652. The embodiments are not limited in this context.

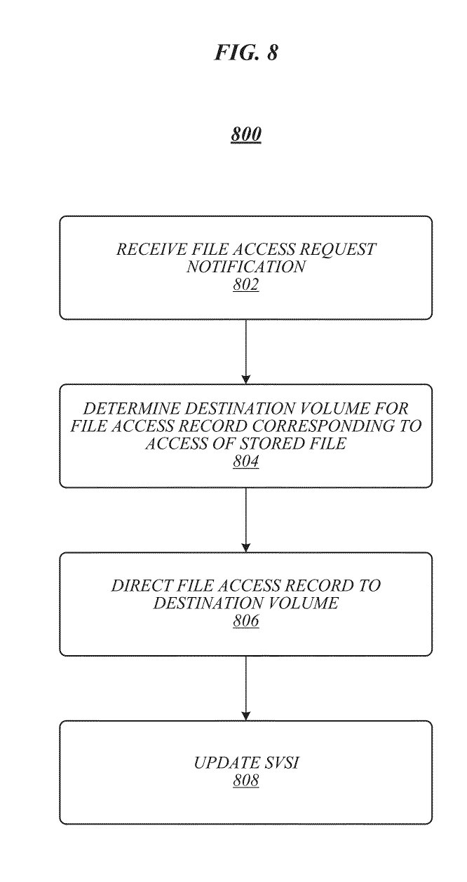

FIG. 8 illustrates an example of a logic flow 800 such as may be representative of operations that may be performed by apparatus 600 and/or system 640 of FIG. 6 in some embodiments. As shown in FIG. 8, a file access request notification may be received at 802. For example, apparatus 600 and/or system 640 of FIG. 6 may be operative to receive file access request notification 618 from networking node 650. At 804, a destination volume may be determined for a file access record corresponding to an access of a stored file. For example, auditing subsystem 606 of FIG. 6 may be operative to determine a destination volume for file access record 622, which may correspond to access to stored file 620 on the part of client 690. At 806, the file access record may be directed to the destination volume. For example, auditing subsystem 606 of FIG. 6 may be operative to direct file access record 622 to the determined destination volume. At 808, SVSI may be updated. For example, auditing subsystem 606 of FIG. 6 may be operative to update SVSI 616. The embodiments are not limited to these examples.

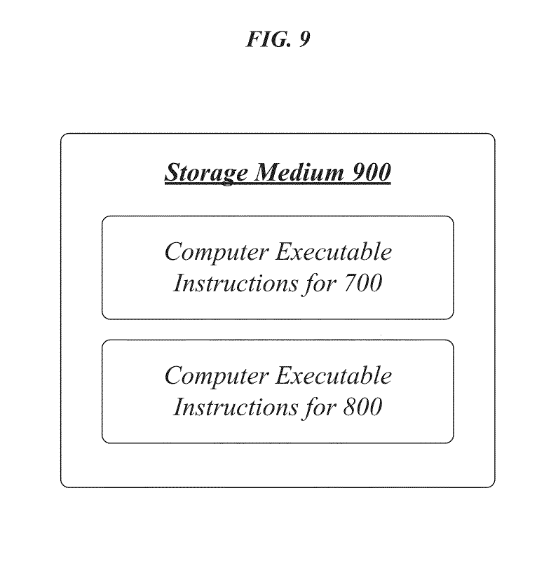

FIG. 9 illustrates an embodiment of a storage medium 900. Storage medium 900 may comprise any non-transitory computer-readable storage medium or machine-readable storage medium, such as an optical, magnetic or semiconductor storage medium. In various embodiments, storage medium 900 may comprise an article of manufacture. In some embodiments, storage medium 900 may store computer-executable instructions, such as computer-executable instructions to implement staging volume selection algorithm 700 of FIG. 7 and/or logic flow 800 of FIG. 8. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

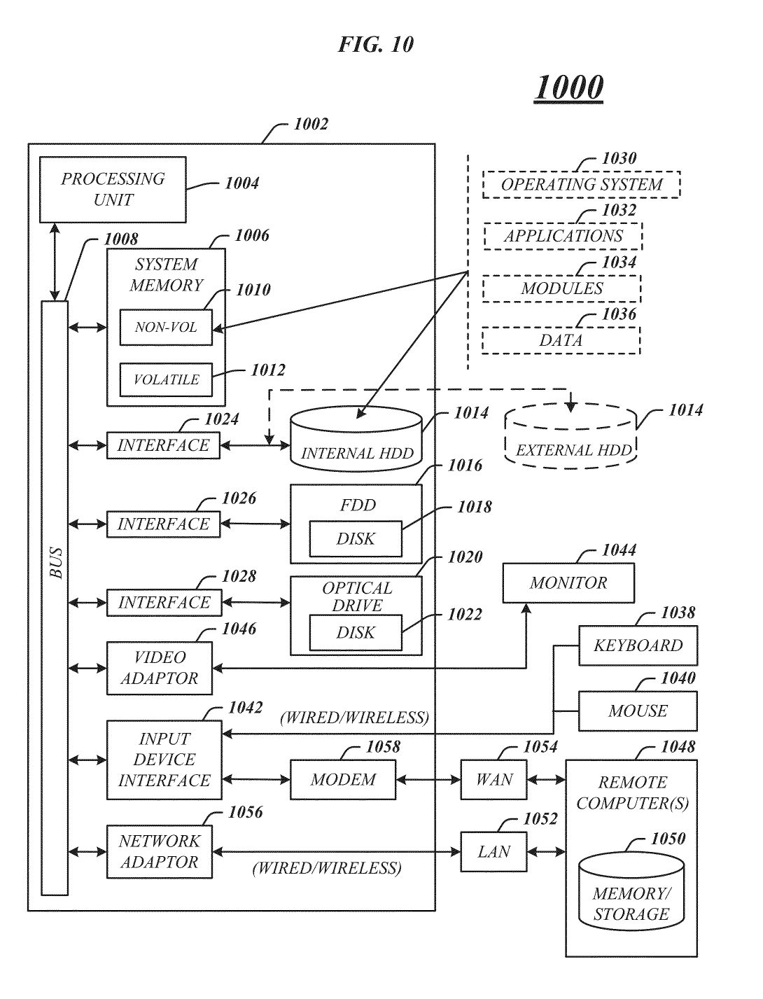

FIG. 10 illustrates an embodiment of an exemplary computing architecture 1000 suitable for implementing various embodiments as previously described. In various embodiments, the computing architecture 1000 may comprise or be implemented as part of an electronic device. In some embodiments, the computing architecture 1000 may be used, for example, to implement apparatus 600 and/or system 640 of FIG. 6, staging volume selection algorithm 700 of FIG. 7, logic flow 800 of FIG. 8, and/or storage medium 900 of FIG. 9. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1000.

As shown in FIG. 10, the computing architecture 1000 comprises a processing unit 1004, a system memory 1006 and a system bus 1008. The processing unit 1004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1004.

The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1012. A basic input/output system (BIOS) can be stored in the non-volatile memory 1010.

The computer 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM or DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1012, including an operating system 1030, one or more application programs 1032, other program modules 1034, and program data 1036. In one embodiment, the one or more application programs 1032, other program modules 1034, and program data 1036 can include, for example, the various applications and/or components of the apparatus 600 and/or system 640.

A user can enter commands and information into the computer 1002 through one or more wire/wireless input devices, for example, a keyboard 1038 and a pointing device, such as a mouse 1040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A monitor 1044 or other type of display device is also connected to the system bus 1008 via an interface, such as a video adaptor 1046. The monitor 1044 may be internal or external to the computer 1002. In addition to the monitor 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

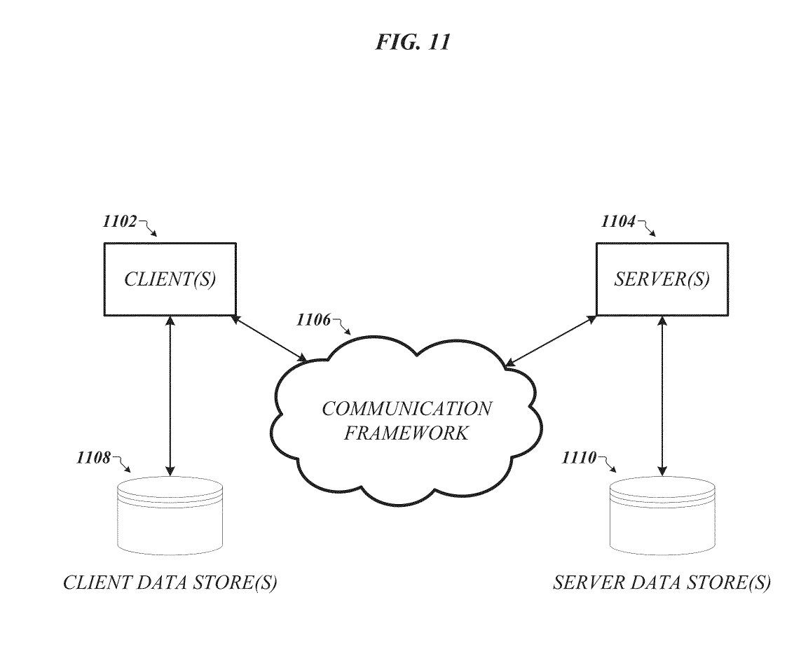

FIG. 11 illustrates a block diagram of an exemplary communications architecture 1100 suitable for implementing various embodiments as previously described. The communications architecture 1100 includes various common communications elements, such as a transmitter, receiver, transceiver, radio, network interface, baseband processor, antenna, amplifiers, filters, power supplies, and so forth. The embodiments, however, are not limited to implementation by the communications architecture 1100.

As shown in FIG. 11, the communications architecture 1100 comprises includes one or more clients 1102 and servers 1104. The clients 1102 and the servers 1104 are operatively connected to one or more respective client data stores 1108 and server data stores 1110 that can be employed to store information local to the respective clients 1102 and servers 1104, such as cookies and/or associated contextual information. Any one of clients 1102 and/or servers 1104 may implement apparatus 600 and/or system 640 of FIG. 6, staging volume selection algorithm 700 of FIG. 7, logic flow 800 of FIG. 8, and/or storage medium 900 of FIG. 9 in conjunction with storage of information on any of client data stores 1108 and/or server data stores 1110.

The clients 1102 and the servers 1104 may communicate information between each other using a communication framework 1106. The communications framework 1106 may implement any well-known communications techniques and protocols. The communications framework 1106 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1106 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1102 and the servers 1104. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a processor circuit; and
a storage medium comprising instructions for execution by the processor circuit to receive a file access request notification identifying a stored file in a storage system, determine a destination volume for a file access record corresponding to an access of the stored file, the destination volume selected from among a plurality of candidate staging volumes of the storage system, and direct the file access record to the destination volume.

2. The apparatus of claim 1, the storage medium comprising instructions for execution by the processor circuit to select the destination volume based on staging volume status information (SVSI) for the plurality of candidate staging volumes.

3. The apparatus of claim 1, the storage medium comprising instructions for execution by the processor circuit to select a native staging volume of the stored file as the destination volume for the file access record in response to a determination that a usage level of the native staging volume is below a dependence threshold.

4. The apparatus of claim 3, the storage medium comprising instructions for execution by the processor circuit to select an alternate staging volume as the destination volume for the file access record in response to a determination that the usage level of the native staging volume is above the dependence threshold.

5. The apparatus of claim 4, the storage medium comprising instructions for execution by the processor circuit to select a native-partner staging volume as the alternate staging volume in response to a determination that a usage level of the native-partner staging volume is below the dependence threshold.

6. The apparatus of claim 4, the storage medium comprising instructions for execution by the processor circuit to select a non-native staging volume as the alternate staging volume in response to a determination that a usage level of the non-native staging volume is below an exclusion threshold.

7. The apparatus of claim 1, the storage medium comprising instructions for execution by the processor circuit to select an auxiliary staging volume as the destination volume in response to a determination that the auxiliary staging volume comprises a lone available storage location for the file access record.

8. The apparatus of claim 1, comprising a storage array.

9. An article comprising at least one non-transitory computer-readable medium comprising a set of instructions that, in response to being executed on a computing device, cause the computing device to:
receive a file access request notification identifying a stored file in a storage system;
determine a destination volume for a file access record corresponding to an access of the stored file, the destination volume selected from among a plurality of candidate staging volumes of the storage system; and
direct the file access record to the destination volume.

10. The article of claim 9, comprising instructions that, in response to being executed on the computing device, cause the computing device to select the destination volume based on staging volume status information (SVSI) for the plurality of candidate staging volumes.

11. The article of claim 9, comprising instructions that, in response to being executed on the computing device, cause the computing device to select a native staging volume of the stored file as the destination volume for the file access record in response to a determination that a usage level of the native staging volume is below a dependence threshold.

12. The article of claim 11, comprising instructions that, in response to being executed on the computing device, cause the computing device to select an alternate staging volume as the destination volume for the file access record in response to a determination that the usage level of the native staging volume is above the dependence threshold.

13. The article of claim 12, comprising instructions that, in response to being executed on the computing device, cause the computing device to select a native-partner staging volume as the alternate staging volume in response to a determination that a usage level of the native-partner staging volume is below the dependence threshold.

14. The article of claim 12, comprising instructions that, in response to being executed on the computing device, cause the computing device to select a non-native staging volume as the alternate staging volume in response to a determination that a usage level of the non-native staging volume is below an exclusion threshold.

15. A computer-implemented method, comprising:
receiving a file access request notification identifying a stored file in a storage system;
determining, by a processor circuit, a destination volume for a file access record corresponding to an access of the stored file, the destination volume selected from among a plurality of candidate staging volumes of the storage system; and
directing the file access record to the destination volume.

16. The computer-implemented method of claim 15, comprising selecting the destination volume based on staging volume status information (SVSI) for the plurality of candidate staging volumes.

17. The computer-implemented method of claim 15, comprising selecting a native staging volume of the stored file as the destination volume for the file access record in response to a determination that a usage level of the native staging volume is below a dependence threshold.

18. The computer-implemented method of claim 17, comprising selecting an alternate staging volume as the destination volume for the file access record in response to a determination that the usage level of the native staging volume is above the dependence threshold.

19. The computer-implemented method of claim 18, comprising selecting a native-partner staging volume as the alternate staging volume in response to a determination that a usage level of the native-partner staging volume is below the dependence threshold.

20. The computer-implemented method of claim 18, comprising selecting a non-native staging volume as the alternate staging volume in response to a determination that a usage level of the non-native staging volume is below an exclusion threshold.
